(19) United States
(12) Patent Application Publication
(10) Pub. No.: US 2008/0095606 A1
(43) Pub. Date: Apr. 24, 2008

(54) Lifting Device

(76) Inventor: Dirk Pierson, Cham (DE)

Correspondence Address: THE CULBERTSON GROUP, P.C., 1114 LOST CREEK BLVD., SUITE 420, AUSTIN, TX, 78746, US

(21) Appl. No.: 11/573,187

(22) PCT Filed: Feb. 13, 2006
(86) PCT No.: PCT/DE06/00251

§ 371 Date: Feb. 2, 2007

(30) Foreign Application Priority Data
Jun. 2, 2005 (DE) 20 2005 008 760.2

(51) Int. Cl. B66C 1/68; B66C 1/42

(52) U.S. Cl. 414/800

(57) ABSTRACT

A lifting device includes a lifting element with at least one holding element supported thereon. The holding element is adapted for holding a section of a human arm to provide support when the hand grips an object which is to be displaced. An operator of the lifting device may place their arm in the holding element and then use their hand to grasp an object to be displaced. The lifting device allows the grasped object to be displaced while the weight of the grasped object is borne through the holding element and lifting element.

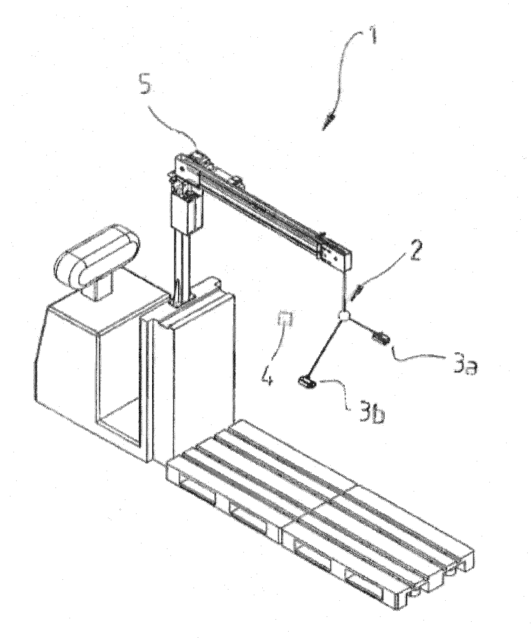

### TECHNICAL FIELD OF THE INVENTION

This invention concerns a lifting device and a method for the movement of objects which are to be displaced.

### BACKGROUND OF THE INVENTION

Work routines during storage or commissioning activities commonly require displacing, putting away, or clearing away objects, packages, bundles etc., which are to be moved or to be displaced from one pallet or shelf to another. With objects which do not weigh very much, such work can be carried out by workers, without requiring special auxiliary equipment for the task, such as cranes.

Furthermore, it is known that equipment such as gripping arms, suction devices, or lifting elements may be used to take up or displace heavy objects. Such lifting or gripping devices are controlled by the operating personnel in order to avoid the manual assumption of the force of the weight and the burden on the human body resulting therefrom.

Also known are so-called “balancers,” which assume or balance the weight of an object (tool, container, etc.), suspended on a flexible device so that a worker moving the tool or the container need not carry its weight himself. Instead, the movement of the suspended object essentially requires only the force for the movement of the worker's own hands or arms.

It has proved disadvantageous, in comparison to this state of the art, that for differently shaped objects, mostly different types of gripping systems are required. Thus, it may be difficult or impossible to satisfactorily stack or otherwise move different objects or goods. Since the auxiliary lifting or gripping devices are not well adaptable to the individual external form of different objects, these auxiliary lifting or gripping devices are generally useful for only certain types of objects.

The problem of the invention, therefore, is to offer a lifting device which is simple to operate and which makes it possible to easily move most differently shaped objects with a low technical expenditure. The problem also is to offer a corresponding method.

### SUMMARY OF THE INVENTION

A lifting device in accordance with the present invention provides a lifting element with at least one holding element supported thereon. The holding element is adapted for holding a section of a human arm to provide support when the hand grips an object which is to be displaced. An operator of the lifting device may place their arm in the holding element and then use their hand to grasp an object to be displaced. The lifting device according to the invention allows the grasped object to be displaced while the weight of the grasped object is borne through the holding element and lifting element.

Therefore, the significance of the invention lies specifically in the fact that while the human hand as such forms the actual gripping tool, the support for the movements of the object to be displaced, which are to be carried out by this human hand, is provided by a lifting element which supports or even drives this movement.

Using the arm sections or their hands, placed in the supported holding elements according to the invention, as individually adaptable gripping tools while the weight of the gripped object is to a large extent borne by the lifting device, greatly facilitates the restacking or displacement of objects. The advantage thereby lies particularly in the fact that heavier loads, which a worker could move only with effort and by endangering his state of health, can be moved in a considerably simpler manner with this lifting device. This is so, in particular, in that the at least one holding element supports the human arm or the hand not far from the point of action of the weight force of the object, so that the body of the worker remains otherwise largely unburdened. The relatively short or even tiny lever arm between the holding element and the point of application of the weight force of the object (for example, in the area of the hand of the worker) moreover makes possible the movement of clearly heavier objects than would have been possible without such a support. At the same time, advantageously, the structure of the apparatus is kept very simple.

In a very simple embodiment of the invention, the lifting element is merely designed in such a way that it is able to take up a weight introduced via its at least one holding element, without necessarily having to carry out an active movement in the vertical direction. In this case, the lifting device merely supports the arms or hands of the worker, so that it can easily carry out a pivoting movement of the object carried by his hands in an essentially horizontal direction, without having to take up vertical weight forces of the object with his entire body. If the entire lifting element can be moved, displaced, pivoted, or the like, in a horizontal direction, then the object supported by the holding elements via the hands of the worker can be moved or pivoted laterally to another site without requiring special muscle force.

Advantageously, the lifting device is constructed in such a manner that a holding element is provided for each of the two arms of a human, so that both hands of a worker are supported by the holding elements in the same way. Basically, however, the model with only one holding element is also conceivable, wherein the hand supported in this way is able to take up a part or also the entire weight of the object to be moved. In this case, the second hand would preferably be used to align and stabilize the object without itself assuming a carrying function.

In one form of the invention, the at least one holding element, which is placed on the lifting element, has a type of loop which goes around the arm section which is to be supported by the holding element. The advantage of such a loop is that a hand inserted through it is conducted relatively securely and is safeguarded against laterally slipping out, that is, transverse to the longitudinal direction of the forearm. Moreover, an arm can be very easily inserted through such a loop or in turn removed from it, so that the use of the lifting device is possible in a simple and quick manner.

A lifting element according to the invention may comprise a rope, strap, belt, etc. which hangs from the lifting device and has, on its lower end, at least on holding element. The holding element in this case may comprise a loop for example. Accordingly, two ropes completely separate from one another or also a divided rope may be used as a lifting element according to the invention, with each rope having a holding element so that both arms of a worker can be supported by the individual holding element.

Alternatively, an element which extends vertically upwards (for example, a hydraulically or pneumatically driven lifting cylinder) may be employed as a lifting element and the at least one holding element may be located on an upper end of such a vertically extending device. Whereas in the case of the suspended rope, the space above the object to be moved must necessarily remain free for just this lifting element (rope), this space can be utilized when the described lifting cylinder is used, for example, to lift objects to a certain level and to push them at this level onto or below a shelf. Depending on the length and type of suspension of the suspended lifting element (for example, rope), such lifting or displacing movements may still be possible with a suspended lifting element.

An alternative embodiment of the lifting device provides for the at least one holding element to have a lateral recess and/or a recess which is open to the top for the insertion of the arm section. In contrast to the previously described loop, there is the possibility here of also making the given arm section mesh with the holding element by a lateral movement, that is, a movement which takes place transversely to the longitudinal direction of the forearm, so as to work with the lifting device. In particular, the holding element may form the shape of a C in cross section with an upper part of the C shape connected to a suspended lifting element. The lateral recess makes it possible for a worker to easily move his arm, so that it can then be placed in the inside lower area of the C-shaped body. Also, an essentially U-shaped holding element is conceivable, where a leg of the U would again be connected to a suspended lifting element (rope). In this case, the arm of the worker would be inserted through the recess essentially from above and would come to lie, in turn, in the lower part of the U. Whereas the previously described loop shape of the holding element guarantees a secure holding of the arm to be supported, the advantage of the U or C shape is that the arms of the worker can be easily placed in the holding element or removed from it.

Another alternative embodiment of the invention provides for the at least one holding element to be essentially designed as a glove, where the glove is coupled to the lifting element and is also capable of holding the hand of the worker. In this case, the lever arm between the point of action of the weight force of the object on the hand and the point of action of the lifting element on the holding element can be advantageously reduced under circumstances down to 0, so that the weight forces to be displaced by the worker can be further reduced and only appear in the hand. Moreover, a holding element constructed as a glove offers a particularly secure hold for the hand within this holding element.

An advantageous embodiment of the lifting device provides for the at least one holding element to be driven by the lifting element vertical and/or horizontal movements. This has the advantage that the lifting element not only supports the inserted arms or hands of a worker but also is able to actively move them and, in particular, lift them. This facilitates the movement of the objects to be displaced between different levels, since the actual lifting work is not carried out by the worker, but rather by the lifting device. In this case, the worker grips the object to be moved with one hand or both hands, which are supported by a holding element, whereupon the lifting movement is driven for the vertical or horizontal movement, so that the arm section resting in the holding element (hand, forearm, hand joint, etc.) can easily follow up with the controlled movement without itself having to produce any appreciable lifting forces. In this way, the displacement of the objects is particularly facilitated, so that, for example, bundles can be lifted from pallets placed at floor level and lifted to a shelf or moved reversely. Since the actual lifting work is hereby carried out by the lifting device in accordance with the invention, the worker is only burdened in this area by the actual weight force of the object to be displaced, although he participates with his hands as an individually adjustable and flexible tool, whereas the rest of his body remains largely unburdened. This represents a considerable simplification in comparison to the state of the art and, moreover, also permits the taking up of such weight forces which could not be otherwise managed simultaneously (several bundles, heavier objects, etc.) without the lifting device in accordance with the invention.

For the case that the lifting device is designed for a vertical and horizontal movement of the at least one holding element, an object to be displaced can therefore not only be lifted or lowered but also be pivoted or moved, particularly in a horizontal direction, without in the meantime the weight having to be borne completely by the worker.

In another embodiment of the invention, provision is made so that there is at least one operating part for the control of the driven movements of the at least one holding element. This operating part causes the corresponding lifting or pivoting movement via the drive, so that the worker need only follow this movement without himself having to exert appreciable forces. The operating part can suitably interact with a control, in particular, via wireless communication. The operating part can then be placed in the area of the at least one holding element or a hand of the worker, so that during the gripping of the object to be moved, the operation of the lifting device is also possible. Also, any other linking of the operating part (for example, to a pedal switch, voice-operated controller, inclination sensor, etc.) may be used within the scope of the present invention.

A particularly advantageous embodiment of the invention includes a lifting device that itself can be moved. In this case, the object to be lifted can be moved, if necessary, over a great distance by the worker holding the object and moving the lifting device to the desired location, where the object is then lowered. In addition to the control of the vertical or horizontal movement of the at least one holding element by the lifting element, it is also possible to control the movements of the entire lifting device via an operating part, in accordance with the invention, which can also be constructed similarly to the previously described operating part or even integrally therewith.

A method in accordance with the invention implements the aforementioned functions and facilitates the development of storage and retrieval tasks. While the unsurpassed flexibility of the human hand as a gripping tool is retained, the rest of the human body is relieved and spared of the forces applied during the displacement. In particular, back problems can thus be simply avoided.

These and other advantages and features of the invention will be apparent from the following description of the exemplary embodiments, considered along with the accompanying drawings.

### BRIEF DESCRIPTION OF THE FIGURE

The FIGURE shows a perspective view of a lifting device in accordance with the invention.

### DESCRIPTION OF EXEMPLARY EMBODIMENTS

As shown in the FIGURE, the lifting device 1 has a cantilever, from the outer end of which a lifting element 2, designed here as a rope, is suspended. On the lower free end of the lifting element 2, there are—divided on two strands—two holding elements 3a and 3b.

These holding elements 3a and 3b are designed as loops, through which an arm of a worker can be inserted, so that a section of the arm rests in or is supported by the holding element 3a, 3b.

The worker, not shown in the FIGURE, may then grip an object, also not shown, with his hands, which have been inserted through the loop-shaped holding elements 3a, 3b.

By means of the schematically represented operating part 4, it is possible to control a drive 5 of the lifting device 1 in such a way that the lifting element 2 is raised or lowered with the holding elements 3a, 3b placed thereon. The operating part 4 may be specifically designed for wireless communication with a controller (not shown) for the lifting device 1.

The lifting device 1 can be driven so that it can be moved freely, for example, in a warehouse.

The above described exemplary embodiments are intended to illustrate the principles of the invention, but not to limit the scope of the invention. Various other embodiments and modifications to these example embodiments may be made by those skilled in the art without departing from the scope of the present invention.

1-17. (canceled)

18. A lifting device for use in moving objects, the lifting device including:
(a) a lifting element; and
(b) a holding element connected to the lifting element, the holding element for supporting a section of a human arm while the hand of the supported arm remains in position to grip an object which is to be moved, the holding element supporting the section of the human arm by taking up the weight of the object being gripped.

19. The lifting device of claim 18 further including a second holding element connected to the lifting element or to an additional lifting element, the second holding element for supporting a section of a second human arm while the hand of the supported second arm remains in position to grip the object, the second holding element supporting the section of the second human arm by taking up the weight of the object being gripped.

20. The lifting device according to claim 18 wherein the holding element comprises a loop that extends completely around the supported arm section above the hand.

21. The lifting device according to claim 18 wherein the holding element includes a laterally opening recess or an upwardly opening recess for receiving the supported arm section.

22. The lifting device according to claim 18 wherein the holding element comprises a glove.

23. The lifting device according to claim 18 further including a drive for moving the holding element vertically or horizontally or both vertically and horizontally.

24. The lifting device according to claim 23 further including an operating part for controlling the operation of the drive to move the holding element.

25. The lifting device according to claim 24 wherein the operating part is located on the holding element.

26. The lifting device according to claim 24 wherein the operating part provides wireless control of the drive.

27. The lifting device according to claim 18 wherein the device is freely movable.

28. A method for moving objects, the method including:
(a) introducing a section of a human arm into a holding element which is connected to a lifting element;
(b) with the hand of the arm introduced into the holding element, gripping the object which is to be moved so as to take up the weight of the object; and
(c) moving the object while the weight of the object is taken up through the hand to the holding element.

29. The method according to claim 28 further including:
(a) introducing a section of a second human arm into a second holding element which is connected to the lifting element or to a second lifting element;
(b) with the hand of the second arm introduced into the second holding element, gripping the object which is to be moved; and
(c) moving the object while the weight of the object is taken up through the hand to the holding element and through the second hand to the second holding element.

30. The method according to claim 28 wherein the holding element comprises a loop that extends completely around the supported arm section above the hand.

31. The method according to claim 28 wherein the holding element includes a laterally opening recess or an upwardly opening recess for receiving the supported arm section.

32. The method according to claim 28 wherein the holding element comprises a glove.

33. The method according to claim 28 further including operating a drive to move the holding element vertically or horizontally or both vertically and horizontally.

34. The method according to claim 33 further including controlling the drive by an operating part.

35. The method according to claim 34 wherein the operating part is located on the holding element.

36. The method according to claim 34 wherein the operating part provides wireless control of the drive.
